(19) United States
(12) Patent Application Publication
(10) Pub. No.: US 2026/0140359 A1
(43) Pub. Date: May 21, 2026

(54) EYE TRACKING CALIBRATION

(71) Applicant: Carl Zeiss Microscopy GmbH, Jena (DE)

(72) Inventor: David Dobbelstein, Oberkochen (DE)

(73) Assignee: Carl Zeiss Microscopy GmbH, Jena (DE)

(21) Appl. No.: 19/382,822

(22) Filed: Nov. 7, 2025

(30) Foreign Application Priority Data
Nov. 19, 2024 (DE) 10 2024 133 935.7
Jul. 8, 2025 (DE) 10 2025 126 611.5

(51) Int. Cl. G02B 21/26; G06F 3/01

(52) U.S. Cl. CPC G02B 21/26; G06F 3/013

(57) ABSTRACT

A module for a microscope comprises an input interface for receiving sensor data from an eye tracking sensor with information relating to the fixation point of the user, for receiving operating data for operating the microscope calibration function and for receiving marking data with information relating to an optical stimulus arranged on the XY table; an analysis unit for determining the fixation point of the user based on the sensor data and for determining a control command for controlling the microscope calibration function based on the operating data and for carrying out a calibration based on the fixation point and the marking data; and an output interface for transmitting the control command to a control unit of the microscope to control the XY table.

### CROSS REFERENCE TO RELATED APPLICATION

This application claims priority to German patent application 10 2024 133 935.7 filed on Nov. 19, 2024, and German patent application 10 2025 126 611.5 filed on Jul. 8, 2025, each of which are hereby incorporated by reference in their entireties.

### TECHNICAL FIELD

The present disclosure relates to a module for a microscope for determining a fixation point of a user and for controlling a microscope calibration function. The present disclosure further relates to a corresponding system as well as a microscope. The present disclosure furthermore relates to a method for operating a microscope as well as the use of a module with a microscope.

### BACKGROUND

An operation of a microscope when looking through one or two eyepieces can be challenging for a user. Microscopes can have operating elements for setting different microscope functions, such as, for example, a focus, a zoom or a movement of the sample underneath the lens. However, the user cannot see said operating elements when he/she looks through the eyepiece or the eyepieces, respectively, of the microscope to observe a sample. The user needs to thus identify the operating elements by touching or has to operate the operating elements blindly, respectively, and check the effects of the operation when looking through the eyepieces.

It is known that microscopes are controlled via rotary knobs, which can be reached easily and which can be operated without direct view of the operating element. For example, a focus and/or a zoom level, thus a magnification of the microscope, can be set using said rotary knobs. However, a movement of the sample or of the preparation, respectively, is occasionally not possible with such rotary knobs. In other words, a navigation, optionally a visual navigation on the sample, is limited to only one degree of freedom, namely the magnification.

In the case of a complete 3D navigation, thus a navigation with three degrees of freedom, in the case of which a lateral movement of the sample is to be carried out as well, the control or operation, respectively, of the microscope becomes more complicated.

It is known to provide for lateral sample movements using a motorized table, optionally a so-called XY table, wherein the sample is moved under the microscope hereby. It is disadvantageous hereby, however, that the control of a table of this type requires an additional user input and sensitivity.

In the case of current devices, for example from Zeiss, it is known to make a user input of this type using a joystick and/or a touchscreen. However, the user input has a high complexity hereby. It is known to change between two alternating modes on the joystick for the 3D navigation, wherein either a zoom level or a sample movement can take place here.

This may pose a risk for incorrect operation and frustration resulting therefrom for a user. Optionally, forgetting the mode switch-over can occur, so that the user performs a sample movement instead of zooming and vice versa.

A navigation on the sample turns out to be challenging and difficult in the case of embodiments of this type.

A microscope is known from the published patent application EP 1 131 663 B1, which is equipped with an eye tracking sensor, wherein the user can control different functions of the microscope with his/her line of sight. It is proposed in this publication that the user can activate a function by looking at different icons. It is to be attained hereby that a user controls the microscope exclusively with his/her eyes. It is disadvantageous hereby that the user has to know exactly which icon he/she has to look at or activate, respectively, for which function. The system is not very intuitive because the user has to initially observe the icons to understand the icons. This can already result in an unintentional activation of functions. The system further only provides for the operation of a single function, which is initially activated in a complex manner by looking at an icon, thus not the sample. The navigation on the sample is made more difficult hereby because the user needs to inevitably glance away from the sample to activate a function.

There is thus a need for providing for an improved operability of a microscope. This need increases with additional functions, which can be integrated in modern microscopes. There is optionally a need for a calibration of the microscope, which can be carried out efficiently and in a comprehensible manner, optionally a calibration with respect to capturing a fixation point.

### SUMMARY

A module for a microscope with an XY table for determining a fixation point of a user and for controlling a microscope calibration function is provided. The module comprises an input interface for receiving sensor data from an eye tracking sensor with information relating to the fixation point of the user, for receiving operating data for operating the microscope calibration function and for receiving marking data with information relating to an optical stimulus arranged on the XY table; an analysis unit for determining the fixation point of the user based on the sensor data and for determining a control command for controlling the microscope calibration function based on the operating data and for carrying out a calibration based on the fixation point and the marking data; and an output interface for transmitting the control command to a control unit of the microscope to control the XY table.

A method for calibrating a microscope is provided, wherein the method comprises receiving sensor data from an eye tracking sensor with information relating to a fixation point of a user; receiving marking data with information relating to an optical stimulus arranged on an XY table of the microscope; determining a position of the fixation point of the user based on the sensor data; determining a position of the stimulus based on the marking data; moving the stimulus using the XY table to a predetermined position; and calibrating the microscope based on the marking data and the sensor data.

### BRIEF DESCRIPTION OF THE DRAWINGS

In the drawings:

FIG. 1 shows a schematic illustration of a system comprising a microscope and an eye tracking sensor for determining the fixation point;

FIG. 2 shows a schematic illustration of a module in a system for operating a microscope;

FIGS. 3a+3b each show a schematic image section for clarifying a function of a microscope;

FIGS. 4a+4b show, analogously to FIGS. 3a and 3b, a schematic illustration of a further function of a microscope;

FIG. 5 shows a schematic illustration of a microscope with a system;

FIG. 6 shows a schematic illustration of a calibration of a microscope; and

FIG. 7 schematically shows the steps of a method according to the disclosure.

### DETAILED DESCRIPTION

The present disclosure may solve the object of specifying an improved option for controlling a microscope. Optionally, a sample navigation is to be improved, wherein a gaze of a user optionally does not need to deviate from the sample for this purpose. In an optional design, an option is to be created for operating a microscope without hands, so that a user's hands are free to work on the sample. Optionally, a calibration of the microscope, optionally a calibration with respect to the capture of a fixation point, is to be simplified.

In an optional first aspect, the present disclosure can relate to a module for a microscope for determining a fixation point of a user and for controlling a microscope calibration function, comprising: an input interface for receiving sensor data from an eye tracking sensor with information relating to a fixation point of the user, for receiving operating data for operating the microscope calibration function and for receiving marking data with information relating to an optical stimulus arranged on the XY table; an analysis unit for determining the fixation point of the user based on the sensor data and for determining a control command for controlling the microscope calibration function based on the operating data and for carrying out a calibration based on the fixation point and the marking data; and an output interface for transmitting the control command to a control unit of the microscope to control the XY table.

In an optional further aspect, the disclosure can relate to a system for determining a fixation point of a user and for controlling a microscope calibration function, comprising: a module as defined herein; an eye tracking sensor for generating sensor data with information relating to a fixation point of the user; an operating unit for generating operating data based on an operating input from the user; an XY table with an optical stimulus arranged thereon; and a unit, optionally a camera, for generating marking data with information relating to the optical stimulus arranged on the XY table.

A further optional aspect of the disclosure can be directed to a microscope with a system as defined herein and at least one control unit, which controls a function of the microscope based on a control command of the analysis unit of the module.

In a further optional aspect, the disclosure can be directed a method for calibrating a microscope with the steps of: receiving sensor data from an eye tracking sensor with information relating to a fixation point of a user; receiving marking data with information relating to an optical stimulus arranged on an XY table of the microscope; determining a position of the fixation point of the user based on the sensor data; determining a position of the stimulus of the user based on the masking data; moving the stimulus using the XY table to a predetermined position; and calibrating the microscope based on the marking data and the sensor data in the case of optionally at least two positions.

In a further optional aspect, the disclosure can relate to a use of a module as defined above with a microscope to control a microscope calibration function of the microscope.

The features mentioned herein are not limited to being used in the respective specified combination but can also be used in other combinations or alone, without departing from the scope of the present disclosure.

Fixation point, focal point or point of interest (POI) of a user can be a point or a region or an area on a sample, which the user looks at. This focal point is optionally available at any time. That is, the focal point on the sample can be determined from the sensor data from an eye tracking sensor and optionally further microscope-specific data. The fixation point can additionally be subject to a weighting, during which the dwell time of the gaze on a region or an area on the sample is captured. Starting at a threshold value for a dwell time of the gaze on this point, this region or this area, a fixation point of increased interest can optionally be recognized. The fixation point can optionally be determined based on a line of sight and a focus of the user. That is, the fixation point can be determined using so-called eye tracking, thus tracking the eye movement of the user. It can optionally be captured based on a known microscope geometry as well as based on an eye position of the user, which region on the sample is observed by the user. That is, the fixation point can also be directed at a moved object, wherein the fixation point is then also moved, so that a sliding or smooth tracking, a so-called smooth pursuit, is carried out. In other words, the gaze is also moved with the moved object.

A microscope function can include all setting and operating options of a microscope, such as, for example, a zoom, thus a magnification level, a focusing, a moving of the sample, a setting of a lighting, a placing of an optical filter, for example of a polarization filter, a turn-on and turn-off of an additional lighting, optionally of a wavelength-dependent additional lighting. A staining of a sample can also be understood as microscope function. Memory functions of a sample image or the like can additionally be understood as functions. Optionally, the calibration of a microscope, of a module of the microscope or of a unit of the microscope can also be understood as a microscope function, optionally as a microscope calibration function.

An XY table or cross table can be a device configured to move objects in two dimensions within a plane and to position the objects accurately. An XY table can consist of two guide systems working linearly, which are optionally arranged at a right angle to one another. By means of the combination of the movements of both guide systems, the object can be positioned at any desired point within the work area.

Eye tracking, also gaze detection or oculography, refers to the recording of the gaze movements of a person, which consist or comprise mainly of fixations, saccades, thus quick eye movements, and regressions.

Devices and systems, which perform a recording or image capturing and which provide for an analysis of the gaze movements, are referred to as eye trackers or eye tracking sensors. An eye tracking sensor or gaze tracking sensor can record and optionally analyze the eye movements of a person. It can be captured thereby what a person is looking at and how long the person fixes on a certain point. This data can be used for analyzing visual perceptions, attentions and cognitive processes.

The input and output interface may be implemented as (physically) separate interfaces or as one input/output interface. The interface(s) can be formed in a wired as well as wireless manner, wherein any standard or also a proprietary communication can be used for this purpose.

By means of an input interface for receiving sensor data from an eye tracking sensor and for receiving operating data for operating the microscope calibration function as well as for receiving marking data and an optical stimulus arranged on the XY table, a module can be created, which can at least partly resort to an already existing infrastructure of the microscope. A module with few component parts can be created.

The input interface and the output interface can be realized purely using software or also in hardware. It is conceivable optionally to use a combined interface, which acts as input as well as output interface.

The use of an optical stimulus for calibrating a microscope and optionally an eye tracking function of the microscope provides for a calibration of the microscope, which is intuitive and which is not susceptible to errors.

By means of an analysis unit, which can determine the fixation point of a user, which can determine a position of the optical stimulus and which can control an XY table, on which an optical stimulus is arranged, using a control command, the analysis unit can also change the position of the optical stimulus and can calculate a calibration of the eye tracking sensor therefrom.

The analysis unit can optionally receive a control command, which starts and/or continues the microscope calibration function. In other words, the module can be put into a calibration mode and can then optionally perform predetermined steps for the calibration.

The unit for generating marking data can be an independent unit, a camara, an optical and/or acoustic sensor or can be implemented completely in software, for example on a control device of the microscope.

The marking data optionally comprises camera data from a camera and/or position data in response to the arrangement of the optical stimulus at an already known position. A user can optionally place the optical stimulus at an already known position using a reticle with graticule or a graticule, which is engraved into the XY table. The calibration can be improved and can optionally be carried out in a user-friendly manner using marking data in the form of camera data and/or position data. An incorrect operation of the calibration function can be counteracted efficiently. That is, the already known position can also be displayed in another way, for example using a laser point or a virtually displayed graticule. In response to shifting the optical stimulus using an XY table, a new position of the optical stimulus can be calculated based on the placement on the already known position. A measurement-based capturing of the position can optionally be omitted hereby. It goes without saying, however, that an already known position can also be captured using measuring and the subsequent position can then be calculated.

In a optional design, the operating data comprises a start signal of the calibration and/or a start signal of a further calibration step. The operating data can optionally be generated via voice command, keystroke, touch input, operation of a joystick and/or operation of a foot pedal. A calibration of the microscope and optionally of the eye tracking sensor can be carried out comfortably hereby. That is, a complete calibration program can be provided, in the case of which the XY table moves the optical stimulus to predefined positions. A tracking of the movement of the optical stimulus can also be part of a calibration routine. A combination of the two above-mentioned methods can optionally also be used for the calibration. The module can be equipped with few technical elements using operating data, which can be generated using operating units, which optionally already exist on the microscope. In an optional design, the module can also be implemented purely using software.

In a further advantageous design, the analysis unit is formed for predetermining a position and/or a trajectory for the XY table based on a calibration step, which is to be performed, and for generating a control command, which causes a movement of the XY table according to the predetermined position and/or the predetermined trajectory. An efficient calibration program can be predetermined hereby and can be stored, for example, in a memory unit or a memory of the module. It can be determined empirically, which positions or which trajectory lead to an efficient calibration. The module can be continuously improved hereby, for example using a software update. Optionally, a calibration performed using the module can be more precise with increasing experience.

In a calibration mode, the analysis unit advantageously determines at least two different positions for the XY table. In an advanced calibration mode, the analysis unit alternatively determines a trajectory for moving the XY table. By moving the XY table, the optical stimulus arranged thereon is likewise moved, whereby a user fixes the optical stimulus with his/her gaze, so that the analysis unit can use a fixation point of the user together with the known position of the optical stimulus for the calibration. An efficient and quick calibration can take place using a calibration mode with at least two different positions. A precision of the calibration can be increased using an advanced calibration mode, which comprises, for example, the traveling along a trajectory.

In an optional design, the analysis unit is formed for using marking data with information relating to any optical stimulus for the calibration. In other words, different optical stimuli can be taught to the module and the latter can then use them for the calibration. A precision of the calibration can be further increased hereby because advantageous stimuli can be used. These stimuli can be adapted optionally to the ambient conditions, thus the point of use of the microscope. A module can additionally be created, which can be delivered and used with few accessories. A predefined optical stimulus does not need to additionally be supplied and used. An efficient and precise calibration of the microscope can take place using the teaching, optionally at the point of use.

In an optional design, the analysis unit is formed for automatically determining, optionally based on a statistical method, when a calibration step and/or the calibration has been completed. The operating comfort of the module can be increased hereby. An incorrect operation can optionally be counteracted. The analysis unit optionally analyses the received data and the calibration calculated therefrom and can continue the calibration, for example based on an error estimation, until the error value falls below a predetermined threshold. In an optional design, the calibration is started, wherein the XY table automatically moves along different positions and/or trajectories and this procedure is performed and possibly repeated until the analysis unit determines a sufficiently small error.

A general teaching, in which the disclosure is included, comprises a module for a microscope for determining a fixation point of a user and for controlling at least one microscope function, comprising:
an input interface for receiving sensor data from an eye tracking sensor with information relating to a fixation point of a user and for receiving operating data for controlling at least one function of the microscope;
an analysis unit for determining a position of the fixation point of the user based on the sensor data and for determining a control command for controlling the at least one function of the microscope based on the operating data; and
an output interface for transmitting the control command to a control unit of the microscope to control at least one function of the microscope, thus to operate the microscope based on the operating data and the fixation point.

A further general teaching, in which the disclosure is included, relates to a system for determining a fixation point of a user and for controlling a microscope function, comprising:
a module as defined above;
an eye tracking sensor for generating sensor data with information relating to a fixation point, thus optionally relating to a line of sight and/or a focus of a user;
an operating unit for generating operating data based on an operating input from the user for controlling at least one function of the microscope.

A general teaching, in which the disclosure is included, comprises a microscope with a system as defined above and at least one control unit, which controls a function of the microscope based on a control command of the analysis unit of the module.

A further general teaching, in which the disclosure is included, comprises a method for operating a microscope with the steps of:
receiving sensor data from an eye tracking sensor with information relating to a fixation point of a user;
receiving operating data for controlling at least one function of the microscope based on an operating input from a user on an operating unit;
determining a position of the fixation point of the user based on the sensor data;
determining a control command for controlling the function of the microscope based on the operating data and the fixation point; and
transmitting the control command to a control unit of the microscope to control at least one function of the microscope.

A further general teaching, in which the disclosure is included, lastly relates to a use of a module as defined above with a microscope to control at least one microscope function of the microscope.

An improved retrofit solution, optionally a retrofit solution of a desired operating function of a microscope, can be created using a system with a module as defined above as well as an eye tracking sensor and an operating unit. Customer requirements can be addressed individually hereby to obtain, for example, a customized solution for improving the operability of a desired function.

The eye tracking sensor can be pushed, for example, over the eyepiece to capture the eye position of a user. A comprehensive retrofit solution, which can be attached quickly, can thus be created.

A microscope equipped with a system of this type offers the opportunity to deliver a microscope with an advantageous control and improved operability to a customer directly upon delivery. In the case of a direct combination of microscope and system, the system can optionally be integrated into the microscope in an advantageous manner.

The analysis unit of the module can be formed, for example, as part of a control unit, which is already installed in the microscope, wherein the system can advantageously resort to an already existing communication infrastructure of the individual modules of the microscope here. That is, the analysis unit can also be formed as part of a PC, which is connected to the microscope.

In an optional design of the general teaching, the input interface is formed for receiving operating data from a joystick, a touchpad, a foot pedal and/or a microphone, thus operating data in the form of a voice command. An operation of the microscope can take place hereby using intuitive and already known input devices and methods. A direction can advantageously be specified intuitively by the line of sight of the user, the fixation point can thus be set, and a control or operation, respectively, of the microscope can additionally take place using known input devices. For example, rotary knobs as well as operating buttons can be used as input devices for a zoom and/or a focus.

The output interface for transmitting the control command to a control unit of an XY table is optionally formed for controlling a sample carrier using the XY table based on an operating input as well as on a fixation point. The control command can cause hereby that the sample is shifted by simply looking at it and making an operating input. After the shifting process, the sample is centered with respect to the fixation point at the time of the operating input. A surrounding area around the fixation point can thereby likewise be observed. A speed of the shifting of the sample, for example by means of the distance between the center and the fixation point, can additionally be determined at the time of the operating input. When the fixation point thus lies on an edge of the section of the sample, a quicker shifting of the sample can take place, so that an efficiency of the work can be increased. To control the function, the gaze can remain on the sample, which simplifies a navigation on the sample. A control command, which causes a triggering of a microscope function, can already be generated when recognizing an operating input. An intensity and/or direction of the operating input can additionally also be recognized and an intensity, severity, height, speed, etc., of the microscope function to be controlled is controlled as a function of the recognized intensity and/or of the recognized direction of the operating input.

In a further optional design of the general teaching, the output interface for transmitting the control command to a control unit of a zoom of the microscope is formed for controlling a zoom of the microscope based on an operating input as well as a fixation point. A zooming, thus a magnifying of the observed section, can take place intuitively using a guided line of sight using this advantageous design. A sample navigation is simplified, so that a user can quickly observe the section in the desired size.

The analysis unit is in each case formed for determining a corresponding control command.

In an optional design of the general teaching, the analysis unit is formed for generating a control command for a focusing unit of a microscope, which effects an automatic focusing on the fixation point. A sample navigation and sample observation can be simplified hereby, optionally in the case of three-dimensional samples. A complex adjusting of the focus is not necessary because the analysis unit can determine, based on the fixation point, optionally in an iterative process, in which plane the fixation point lies, and then generates a control command, which focusses the microscope at said plane. For example, an area around the fixation point can be used for the automatic focus to specifically focus on this area. A so-called focusing can be triggered, which then only considers this area in its focus optimization.

In a further optional design of the general teaching, the analysis unit is formed for synchronizing the control command for controlling the control unit of an XY table and the control command for controlling the zoom as well as optionally the control command for a focusing unit to improve a sample navigation. It can be attained using the advantageous synchronization of the above-mentioned control commands that the sample is centered and that zooming into the sample takes place at the same time. A navigation takes place on the sample, which can be captured intuitively and which can be carried out quickly. This provides for a highly efficient working with the microscope because an efficient control of three degrees of freedom, thus a moving of the sample and of a zoom, for example from a touch navigation using digital maps, is known. The present disclosure provides for a similarly efficient control of three degrees of freedom under the microscope in an advantageous manner. It is optionally conceivable that a movement speed of the sample or of the image of the sample, respectively, can always be of equal height, independently of the zoom level, to further improve an operability and sample navigation. The movement speed of the XY table can thus be a function of the zoom level, so that a speed of the sample movement takes place quasi independently of the zoom level in a user perception.

In an advantageous design of the general teaching, the analysis unit is formed for determining a user based on the sensor data and for loading a predetermined user profile for the microscope based on the determined user. An efficiency and operability of the microscope can be further improved and can optionally be accelerated hereby. For example, presets of the microscope, such as a pupil distance of the user, can be stored in the loaded profile. The microscope can thus be automatically set to the correct pupil distance. Other user-specific data, such as an optional zoom level at the beginning of the sample observation, a lighting intensity, a contrast or the like can also be stored. It is optionally also conceivable to authorize a user so that only an authorized user can observe the sample.

A simultaneous navigation, optionally with respect to three axes, thus zoom and movement of the sample, as well as the field of view of the microscope, can be possible as efficient interaction when looking through the eyepieces, using the disclosed teaching.

The above-mentioned module, optionally the eye tracking sensor of the module, can be integrated directly into the eyepieces or can be realized as additional module, for example for placing onto the eyepieces.

Optionally the disclosed teaching can be realized in a method with the steps as follows or a device for carrying out the following steps: recognizing an operating input; tapping the focal point at the time of registering the operating input; calculating a necessary XY table movement to center the sample with respect to the focal point; executing a control command and causing a table centering of the XY table; and/or recognizing an operating input; tapping the focal point at the time of the operating input; determining a region or an image section, respectively, around the focal point; using the image section for a focusing.

For carrying out the method, the device can have a specific characteristic, optionally on the module side, as follows: an eye tracking module as well as at least one input modality for a control command of a controllable XY table and/or of a controllable zoom.

Alternatively or additionally, an eye tracking module can be combined with a second input modality for the control command of a controllable focus.

A history of the focal points can be recorded continuously over time optionally in the case of operating inputs, in the case of which the input process requires a period of time, such as, for example, in the case of voice commands. The focal point at the beginning of the operating input, thus, for example, of the voice command, is subsequently used optionally for generating the control command.

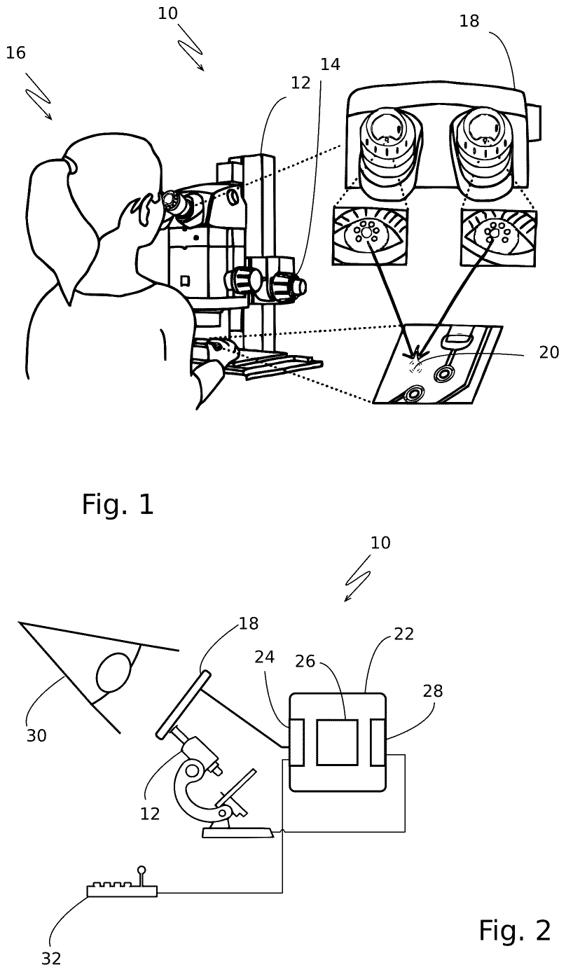

A system 10 comprising a microscope 12 with operating elements 14 as well as an eye tracking sensor 18, which measures the eye movements of a user 16, is shown in simplified illustration in FIG. 1.

In the implementation, an analysis unit is integrated into the eye tracking sensor 18 to determine a fixation point 20 based on the eye position of the user 16.

The operating elements 14 of the microscope 12 are illustrated as rotary knobs. That is, different operating elements 14 can also be used. The selected representation serves to better understand the disclosure.

It is optionally conceivable that the operating elements 14 can be operated by hand as well as electrically, wherein an electric actuator causes a rotation of the operating elements 14 and the functions, such as, for example, a focusing and/or zoom function, thus magnification function, is performed in this way.

The system 10 thus makes it possible to capture a fixation point 20 of the user 16 and to control at least one operating function, for example a zoom function of the microscope 12, based on the fixation point 20.

A further system 10 is shown schematically in simplified illustration in FIG. 2.

The system 10 comprises a module 22 for a microscope 12 for determining a fixation point of a user for controlling at least one function of the microscope 12.

That is, the selected illustration for the microscope 12 is only of an exemplary nature.

The module 22 comprises an input interface 24, an analysis unit 26 and an output interface 28.

The input interface 24 is formed for receiving sensor data from an eye tracking sensor 18 with information relating to a fixation point, thus optionally a line of sight and/or a focus of a user. The input interface 24 is additionally formed for receiving operating data from at least one operating unit 32.

The operating data as well as the sensor data are processed by the analysis unit 26, wherein the analysis unit 26 determines the position of the fixation point on the sample and/or an image of the sample from the sensor data.

The analysis unit 26 further determines a control command for controlling at least one function of the microscope 12 based on the fixation point as well as the operating input or the operating data, respectively, which is generated using the operating unit 32.

The output interface 28 is formed for transmitting the control command determined by the analysis unit 26 to the microscope 12, optionally to a control unit of the microscope 12.

To clarify the setup, an eye 30 of the user is illustrated in a schematically simplified manner.

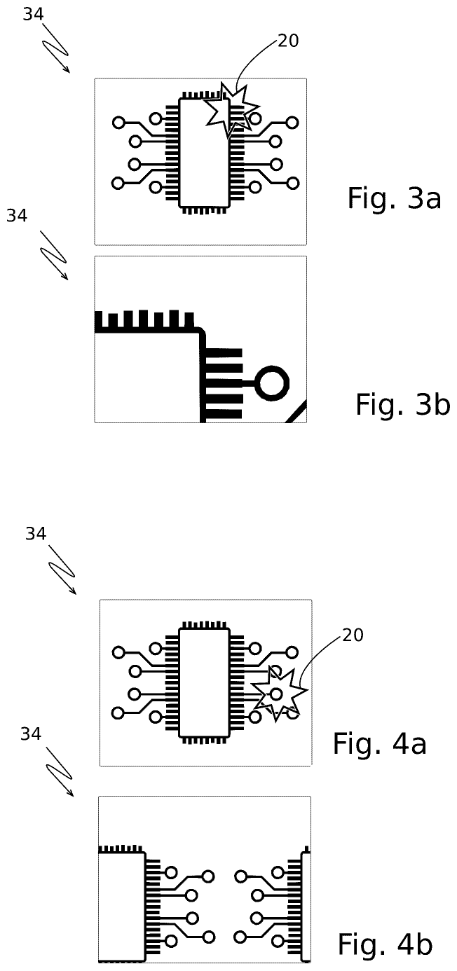

An image section 34 of a sample is illustrated in a simplified manner in FIGS. 3a and 3b to clarify the mode of action of the disclosure.

In FIG. 3a, the sample comprises a circuit. The latter is illustrated at a low zoom level, wherein a fixation point 20 is located at the upper image edge so as to be offset slightly right to the center.

If a user selects the function of zooming using an operating unit, the analysis unit of the module calculates the position of the fixation point 20 on the image and generates a control command to zoom into the area marked by the fixation point using the microscope.

The result of this operating process is illustrated in a simplified manner in FIG. 3b.

The mode of action of a further function is illustrated analogously in FIGS. 4a and 4b.

In contrast to FIGS. 3a and 3b, no zoom, but a moving of the sample is illustrated in FIGS. 4a and 4b.

The moving can be carried out, for example, using an XY table, on which a sample carrier is arranged. A control command can be executed thereby, which causes a moving of the sample in two dimensions, thus in the X direction and/or in the Y direction.

The initial situation is illustrated in FIG. 4a, wherein a fixation point 20 was recognized on the right image edge.

If the user requests, by using a corresponding operating input, that the sample is moved, the analysis unit determines a control command, which causes that the sample is moved by the XY table in such a way that the area of the sample determined by the fixation point 20 is located in a centered manner, centrally, in the image section after moving the sample.

For the sake of clarity, the fixation point 20 is no longer illustrated in FIGS. 3b and 4b.

In an optional design, a shifting of the sample as well as a zooming into the sample can take place in a synchronized manner. A user can request via operating input hereby that the sample is centered about the fixation point on the one hand and that zooming into the fixation point takes place on the other hand.

A speed of the sample movement according to the selected zoom level can advantageously be adapted hereby, so that the sample always moves at the same speed under the microscope for the observer.

In other words, this means that a low movement speed is carried out using the XY table for a high zoom level and vice versa.

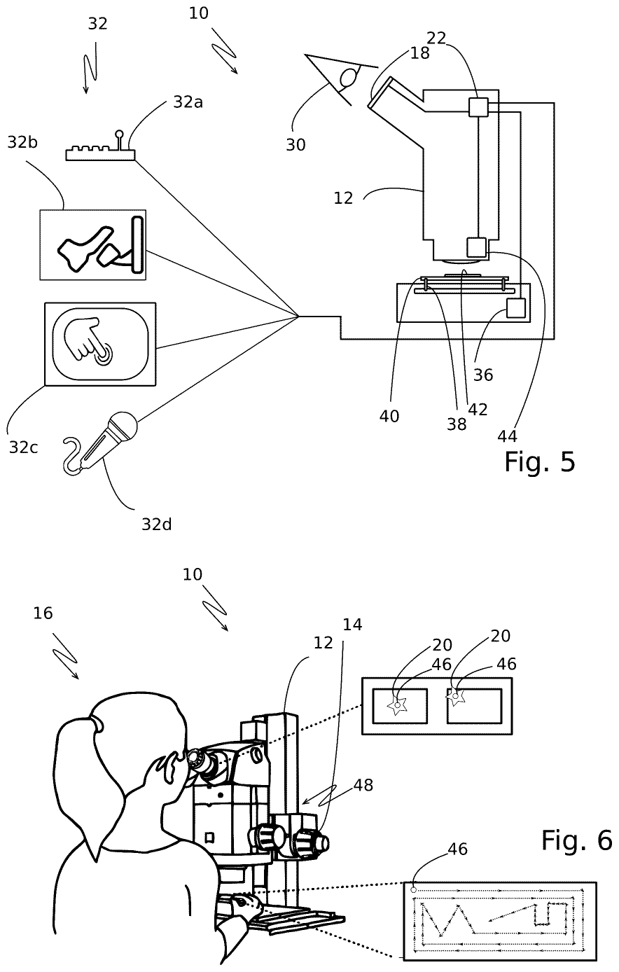

A system 10 is illustrated in more detail in FIG. 5.

The system 10 comprises a microscope 12, on which an eye tracking sensor 18 as well as a module 22 are arranged.

An input interface of the module 22 is connected to one or several operating units 32, wherein the operating units 32 can be formed as joystick with keypad 32a, as foot pedal 32b, as touchpad 32c and/or as microphone 32d for operating via voice command.

The module 22 is further connected to a control unit 36 for controlling an XY table 38, wherein a sample carrier 40, on which a sample 42 is arranged, is connected to the XY table 38.

The microscope 12 additionally comprises a control unit 44 for controlling a zoom function and optionally autofocus function, wherein the control unit 44 is likewise connected to the module 22.

An operating unit in the form of a foot pedal 32b or in the form of a microphone 32d offers the advantage that the hands of a user remain free when operating the microscope 12, so that a manual manipulation can also be carried out on the sample 42 parallel to operating the microscope 12.

The sample 42 can optionally be worked on by observing the sample 42 using the microscope 12.

An operating unit 32 in the form of a joystick with keypad 32a or in the form of a touchpad 32c offers the advantage that the operation can take place highly intuitively because a user often uses operating units 32 of this type in everyday life.

Analogously to FIG. 1, a microscope 12 is illustrated in FIG. 6 while carrying out a calibration of the eye tracking sensor.

A field of view of a user 16 is illustrated schematically in a simplified manner in the figure on the top right, wherein an optical stimulus 46 is captured by the user 16 in the subsection on the top left. This is illustrated in FIG. 6 using the fixation point 20, which lies on the optical stimulus 46.

During the calibration, the optical stimulus 46 can then be moved using the XY table, so that the optical stimulus 46 is located at a different position. The user 16 will track the optical stimulus 46 with his/her gaze, so that the fixation point 20 of the user 16 likewise lies at this new position. This is illustrated in the upper right subsection of FIG. 6.

The microscope 12 likewise has a camera 48, which captures the sample image, thus optionally a reflection of the XY table and of the optical stimulus 46 located thereon. This camera 48 is optionally integrated into the microscope 12. For the sake of clarity, an explicit illustration of the camera 48 has been forgone in the drawing.

A movement pattern of the optical stimulus 46, which can be caused by the movement of the XY table, is illustrated schematically in FIG. 6 in a schematically simplified dashed manner on the bottom right. The illustration is of a schematic nature and serves to better understand the disclosure. The disclosure is optionally not limited to the trajectory, which is selected in an exemplary manner, or to the positions according to FIG. 6, which are selected in an exemplary manner.

The calibration can be carried out on the basis of a discrete position and/or based on a tracking of a trajectory of the optical stimulus 46 when moving the optical stimulus 46.

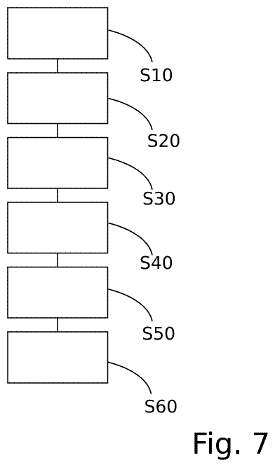

The steps of a method according to the disclosure for calibrating a microscope are illustrated schematically in FIG. 7.

Receiving of sensor data from an eye tracking sensor with information relating to a fixation point of a user takes place in a first step S10.

Marking data, optionally camera data, with information relating to an optical stimulus arranged on an XY table of the microscope, is received in a second step S20.

Determining a position of the fixation point of the user based on the sensor data takes place in a third step S30.

A position of the stimulus of the user based on the marking data is determined in a fourth step S40.

Lastly, the stimulus is moved using the XY table to a predetermined position in a fifth step S50.

A calibration of the microscope based on the marking data and the sensor data in the case of optionally at least two positions of the optical stimulus or XY table, respectively, takes place in a sixth step S60.

The disclosure was described and explained comprehensively based on the drawings and the description. The description and explanation are to be understood as examples and not in a limiting manner. The disclosure is not limited to the disclosed embodiments. Other embodiments or variations follow for the person of skill in the art when using the present disclosure as well as during an exact analysis of the drawings, of the disclosure and of the following patent claims.

The words “comprising” and “with” in the patent claims do not rule out the presence of further elements or steps. The indefinite article “a” or “an” does not rule out the presence of a plurality. An individual element or an individual unit can carry out the functions of several of the units mentioned in the patent claims. An element, a unit, an interface, a device and a system can partly or completely be implemented in hardware and/or software. The pure naming of some measures in several different dependent patent claims is to not be understood to the effect that a combination of these measures cannot likewise be used in an advantageous manner.

### REFERENCE SYMBOLS

10 system
12 microscope
14 operating element
16 user
18 eye tracking sensor
20 fixation point
22 module
24 input interface
26 analysis unit
28 output interface
30 eye
32 operating unit
32a joystick with keypad
32b foot pedal
32c touchpad
32d microphone
34 image section
36 control unit for XY table
38 XY table
40 sample carrier
42 sample
44 control unit for zoom and/or autofocus function
46 optical stimulus
48 camera
S10 to S60 steps of a method according to the disclosure

What is claimed is:

1. A module for a microscope with an XY table for determining a fixation point of a user and for controlling a microscope calibration function, comprising:
an input interface for receiving sensor data from an eye tracking sensor with information relating to the fixation point of the user, for receiving operating data for operating the microscope calibration function and for receiving marking data with information relating to an optical stimulus arranged on the XY table;
an analysis unit for determining the fixation point of the user based on the sensor data and for determining a control command for controlling the microscope calibration function based on the operating data and for carrying out a calibration based on the fixation point and the marking data; and
an output interface for transmitting the control command to a control unit of the microscope to control the XY table.

2. The module according to claim 1, wherein the marking data includes at least one of a camera data from a camera and position data in response to the arrangement of the optical stimulus at an already known position.

3. The module according to claim 2, wherein the module is configured to allow the user to place the optical stimulus at the already known position using a reticle with graticule or a graticule, which is engraved into the XY table.

4. The module according to claim 1, wherein the operating data includes a start signal of the calibration and/or a start signal of a further calibration step.

5. The module according to claim 4, wherein the operating data is generated via at least one: a voice command, a keystroke, a touch input, an operation of a joystick, and an operation of a foot pedal.

6. The module according to claim 1, wherein the analysis unit is configured to predetermine a position and/or a trajectory for the XY table based on a calibration step, which is to be performed, and for generating a control command, which effects a movement of the XY table according to the predetermined position and/or the predetermined trajectory.

7. The module according to claim 6, wherein, the analysis unit determines at least two different positions for the XY table in a calibration mode and/or the trajectory for moving the XY table in an advanced calibration mode.

8. The module according to claim 1, wherein the analysis unit is configured to use the marking data with information relating to any optical stimulus for the calibration.

9. The module according to claim 1, wherein the analysis unit is configured to automatically determine when a calibration step and/or the calibration has been completed.

10. The module according to claim 9, wherein the analysis unit is configured to automatically determine when a calibration step and/or the calibration has been completed, based on a statistical method.

11. A system for determining a fixation point of a user and for controlling a microscope calibration function, comprising:
a module according to claim 1;
the eye tracking sensor for generating the sensor data with the information relating to the fixation point of the user;
an operating unit for generating the operating data based on an operating input from the user;
the XY table with the optical stimulus arranged thereon; and
a unit for generating the marking data with the information relating to the optical stimulus arranged on the XY table.

12. A microscope with the system according to the claim 11 and the control unit, which controls the microscope calibration function of the microscope based on the control command of the analysis unit of the module.

13. A method for calibrating a microscope, comprising:
receiving sensor data from an eye tracking sensor with information relating to a fixation point of a user;
receiving marking data with information relating to an optical stimulus arranged on an XY table of the microscope;
determining a position of the fixation point of the user based on the sensor data;
determining a position of the stimulus based on the marking data;
moving the stimulus using the XY table to a predetermined position; and
calibrating the microscope based on the marking data and the sensor data.
